(19) United States
(12) Patent Application Publication
(10) Pub. No.: US 2012/0018291 A1
(43) Pub. Date: Jan. 26, 2012

(54) SWITCH ASSEMBLY

(75) Inventor: KAI-GUI WANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 12/910,813

(22) Filed: Oct. 24, 2010

(30) Foreign Application Priority Data
Jul. 23, 2010 (CN) 201010234697.0

(51) Int. Cl. H01H 13/70

(52) U.S. Cl. 200/5 R

(57) ABSTRACT

A switch assembly includes a cover, a main body, a base and a fixing member to connect the cover with the base. The cover is fixed to the base to define a space for the main body. Two switch elements are disposed apart from each other on the base. The main body includes two buttons connected by a connection element. The connection element includes a combination portion, two elastic arms and two connection portions. The combination portion is fixed to the base. The elastic arms extend respectively upwards from the combination portion. The elastic arms are respectively connected to one end of the connection portion away from the combination portion.

### BACKGROUND

1. Technical Field

The present disclosure relates to switches, more particularly to a button switch assembly.

2. Description of Related Art

Conventionally, a switch assembly has a button and applying pressure to the button operates it, and the button is supported by an elastic support body such as a spring. The button is pressed down against a supporting force of the elastic support body, so that a movable contact integrally formed with the button comes into contact with a fixed contact, so that an electrical circuit is rendered conductive. It is simple to manufacture the switch assembly. However, if a switch assembly has more than two buttons, it is often difficult to manufacture the switch assembly and assemble the two buttons together.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded view of a switch assembly in accordance with an exemplary embodiment, including a cover, a main body and a base.

FIG. 2 is a perspective view of the cover of the switch assembly of FIG. 1.

FIG. 3 is a perspective view of the main body of the switch assembly of FIG. 1.

FIG. 4 is a side view of the main body of the switch assembly of FIG. 1.

FIG. 5 is a perspective view of the base of the switch assembly of FIG. 1.

FIG. 6 is an exploded view of the switch assembly of FIG. 1 from a reverse direction to FIG. 1.

FIG. 7 is a cross-section of the of the switch assembly of FIG. 1.

### DETAILED DESCRIPTION

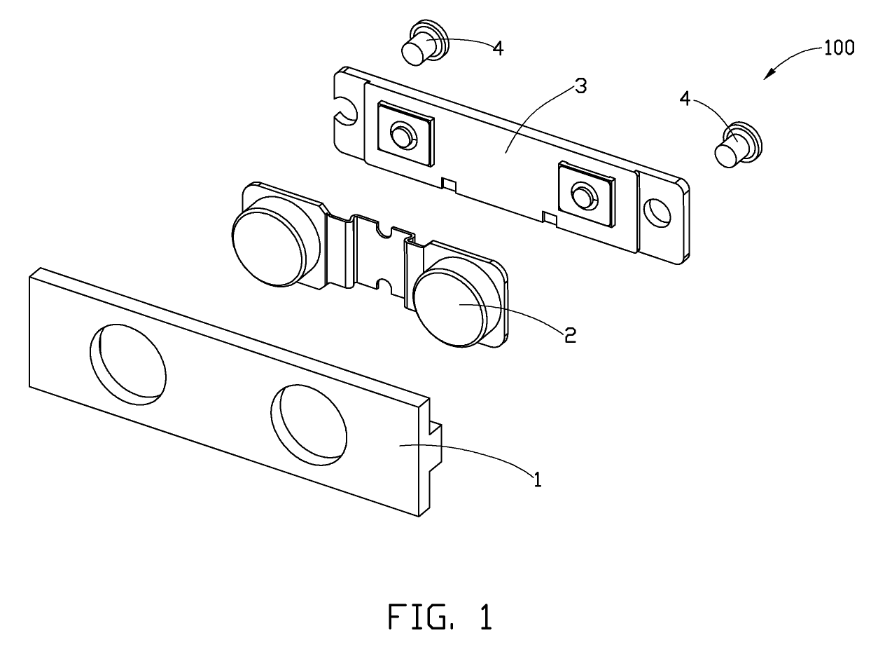

Referring to FIG. 1, a switch assembly 100 includes a cover 1, a main body 2, a base 3, and a fixing member 4 fixing the cover 1 to the base 3. The cover 1 and the base 3 cooperate to form a housing and define a space accommodating the main body 2.

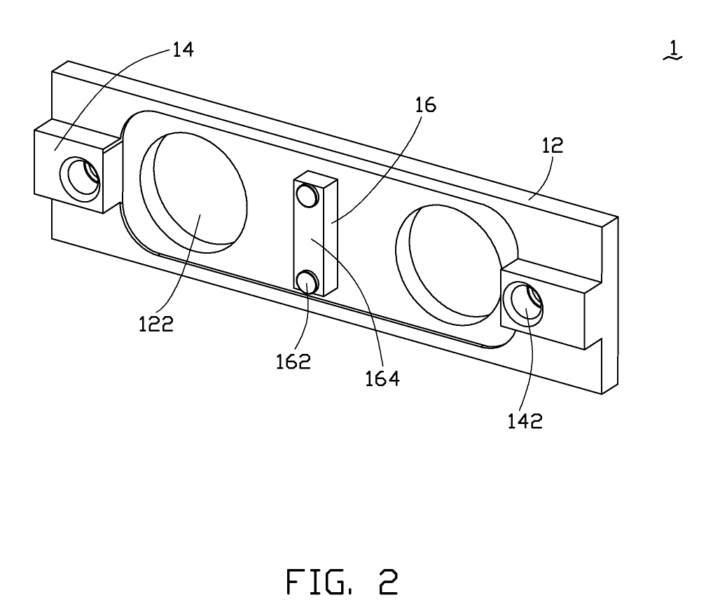

As shown in FIG. 2, the cover 1 may be rectangular and may include a cover plate 12, a pair of connection members 14, and a positioning member 16. The cover plate 12 has a bottom surface. The positioning member 16 is disposed on the middle of the bottom surface of the cover plate 12. The connection members 14 are disposed on the bottom surface of the cover plate 12 and respectively on opposite ends of the cover plate 12. Two first through holes 122 are spaced in the cover plate 12. Each connection member 14 may be a rectangular protrusion with a threaded hole 142 defined therein. The positioning member 16 includes a rectangular block 164 and a protruding post 162 disposed on the block 162. The protruding post 162 is not limited to the cylinder shown in the embodiment.

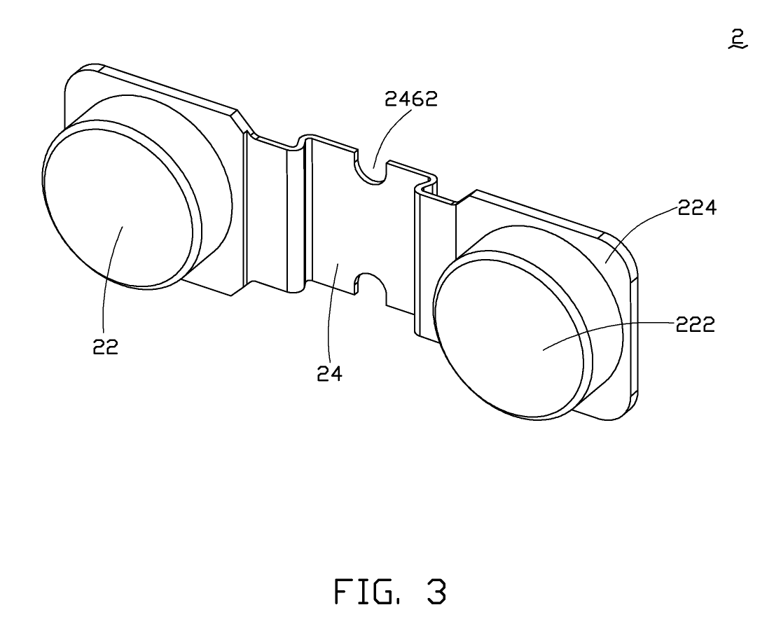

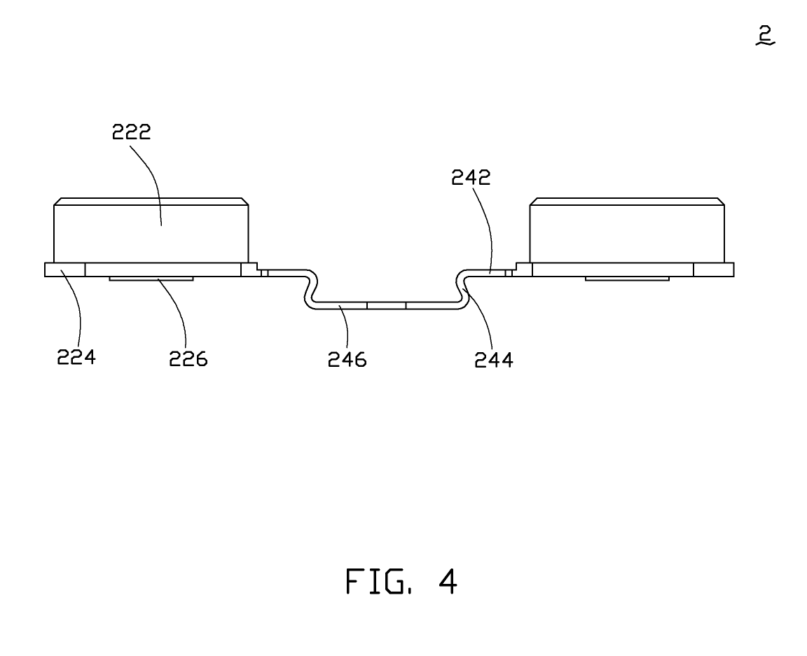

Referring to FIG. 3 and FIG. 4, the main body 2 includes two buttons 22 connected by a connection element 24. Each button 22 includes a key 222, a support board 224 and a triggering portion 226. Each support board 224 supports the corresponding key 222. The triggering portion 226 projects from a bottom surface of the support board 224. The height of each key 222 is slightly larger than that of the each through hole 122. The support boards 224 can be fixed to the connection element 24 or integrally formed with the connection element 24. In the embodiment, two support boards 224 are respectively connected to opposite ends of the connection element 24. Each triggering portion 226 may be a metal piece mounted on the bottom surface of each support board 224 so as to trigger the switch assembly 100.

The connection element 24 may be an integrated metal piece which includes two elastic arms 242, two connection portions 244, and a combination portion 246. The connection portions 244 extends respectively and upwardly from two opposite ends of the combination portion 246 and both angle towards the combination portion 246. Each button 22 is connected to corresponding connection portion 244 by each elastic arm 242. A first acute angle is formed by each connection portion 244 and the combination portion 246. The combination portion 246 is parallel to the elastic arms 242. A second acute angle is formed by each connection portion 244 and the corresponding elastic portion 246. The value of the first acute angle may be equal to that of the second acute angle. Two openings 2462 are defined respectively on two opposite edges of the combination portion 246. Each opening 2462 is semicircular with the diameter thereof equaling or exceeding that of each protruding post 162, which can be received in the corresponding opening 2462 accordingly.

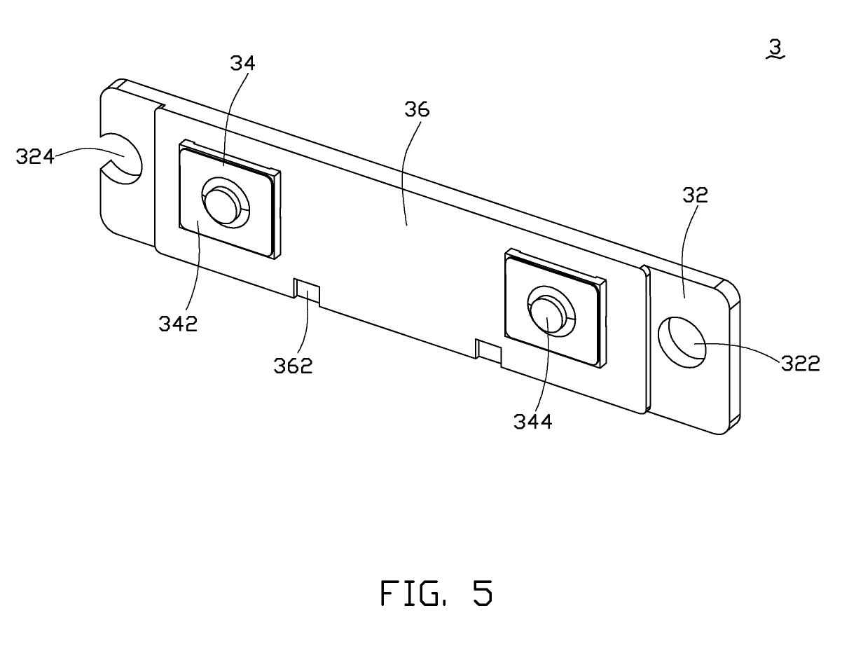

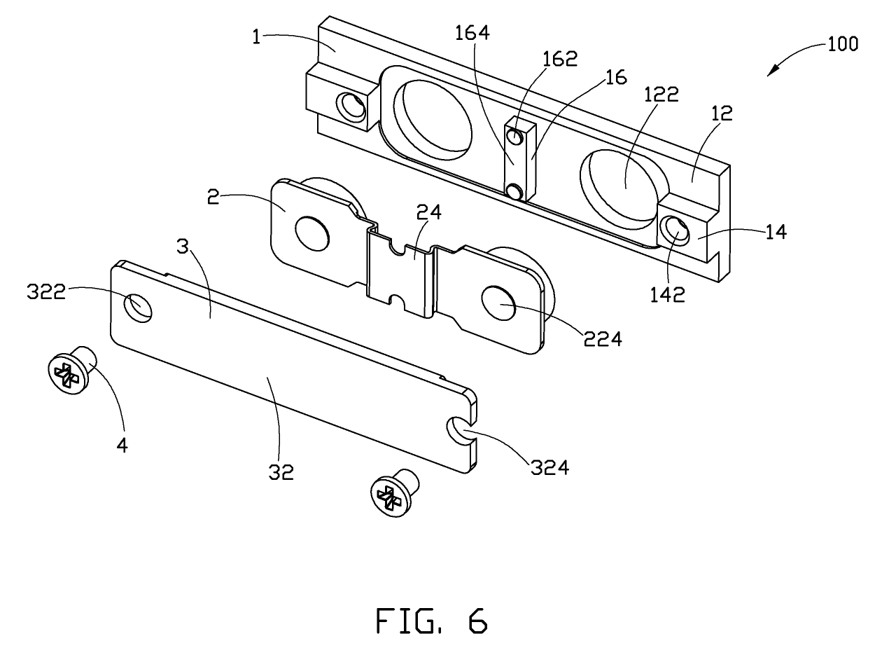

As shown in FIG. 5 and FIG. 6, the base 3 may include a baseboard 32, a circuit board 36 and two switches 34 arranged on the baseboard 32. A second through hole 322 and a third through hole 324 are defined on opposite ends of the baseboard 32. The switches 34 are disposed on the circuit board 36. Each switch 34 includes one switch element 344 and a switch base 342 to support the switch element 344.

In the embodiment, the fixing members 4 are fasteners. The fasteners 4 respectively pass through the second through hole 322 and the third through hole 324 and are received in the threaded holes 142 in the cover 1, thereby connecting the cover 1 with the base 3.

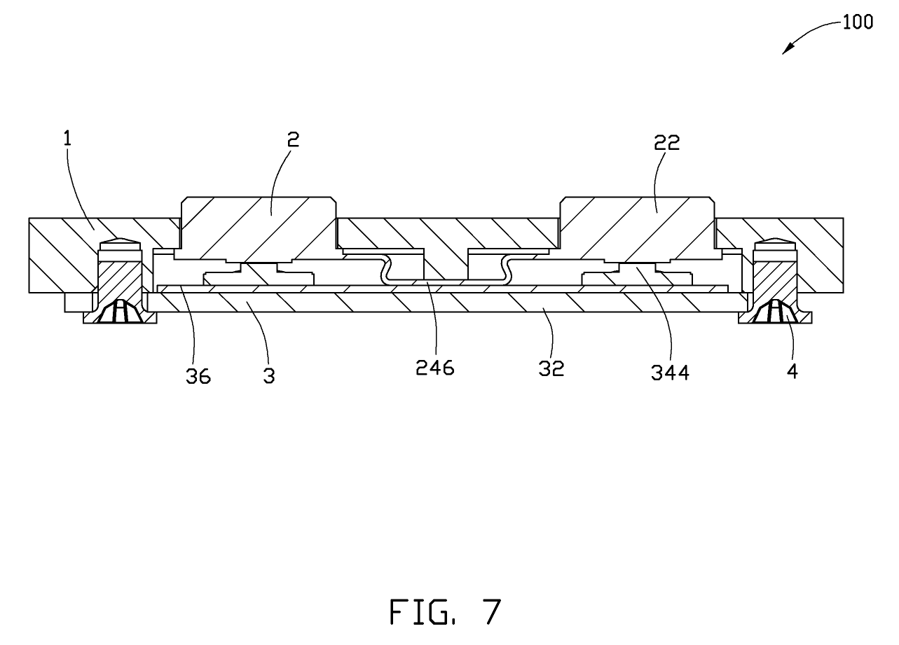

Referring to FIG. 7, during assembly, at first, the base 3 can be put on a flat surface or kept in hand with the main body 2 being placed on top of the base 3. At this time, the elastic arms 242 are parallel to the circuit board 36. The combination portion 246 is arranged on the circuit board 36 to avoid displacement. The cover 1 is fixed to the main body 2 with the protruding posts 162 being received in the openings 2462. At this time, the threaded holes 142 in the cover plate 12, the second through holes 322 and the third through holes 324 in the baseboard 32 form a row. By passing each fixing member 142 through corresponding second through hole 322 and third through hole 324 and threaded hole 142, the cover 1, the main body 2, and the base 3 can be assembled together.

When one of the buttons 22 receives external force, the corresponding button 22 moves towards the base 3 and contacts corresponding switch member 344 to trigger the switch-controlling circuit on the baseboard 3. As the external force is transferred to the connection portion 244, the connection portion 244 can spilt the external force into two component forces. In detail, the external force is spilt into a first component force and a second component force. The first component force faces a second direction approximately parallel to the base 3. Since each connection portion 244 angles towards the combination portion 246, the second component force faces another direction opposite to the second direction. Thus the second component force can offset the effect of the first component force, maintaining the corresponding button 22 parallel to the base. As a result, friction between the button 22 and the corresponding first through hole 122 is decreased.

Since buttons 22 connect by the connection element 24 and the combination portion 246 fixed to the base 3, no further external force can be transferred to the other button 22. That is, the combination portion 246 can prevent the external force from affecting other buttons 22, which will not interfere when button 22 is pressed.

It is to be understood that with the connection element 24, the two buttons 22 can be assembled together conveniently. Moreover, with the combination portion 246 and the connection portion 244, the buttons 22 do not interfere and friction between the button 22 and the corresponding first through hole 122 can be decreased when one button 22 is pressed.

It is to be understood, however, that even though information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A switch assembly, comprising:
a base with at least two switch elements disposed thereon;
at least two buttons corresponding to the at least two switch elements;
a connection element configured for connecting the at least two buttons, the connection element comprising a combination portion fixed to the base and at least two elastic arms connected to the combination portion, the at least two buttons being disposed on the at least two elastic arms respectively.

2. The switch assembly as claimed in claim 1, wherein each elastic arm is connected to the combination portion through a connection portion.

3. The switch assembly as claimed in claim 2, wherein the connection portion extends upwardly from the combination portion, and the elastic arm is connected to an end of the connection portion which is away from the combination portion.

4. The switch assembly as claimed in claim 3, wherein a first acute angle is formed by the connection portion and the combination portion.

5. The switch assembly as claimed in claim 4, wherein the elastic arms are parallel to the combination portion and the base.

6. The switch assembly as claimed in claim 5, wherein a second acute angle is formed by the connection portion and the corresponding elastic arm.

7. The switch assembly as claimed in claim 1, wherein the switch assembly further comprises a cover engaging with the base to define a space for accommodating the switch element, the connection element and the buttons.

8. The switch assembly as claimed in claim 7, wherein at least two first through holes are defined in the cover for receiving the at least two buttons respectively.

9. The switch assembly as claimed in claim 8, wherein the cover further comprises a positioning member for fixing the combination portion to the base.

10. The switch assembly as claimed in claim 9, wherein the positioning member includes a block and a protruding post projecting from the block, the combination portion defines two openings corresponding to the protruding posts, the protruding posts protrudes out of the corresponding opening, and the block engages with the openings and the combination portion to fix the connection member.

11. A switch assembly, comprising:
a housing;
at least two switch elements;
at least two buttons;
a connection element comprising a combination portion fixed to the housing and at least two elastic arms connected to the combination portion, the at least two buttons being mounted on the at least two elastic arms respectively such that the at least two buttons are capable of triggering the at least two switch elements respectively.

12. The switch assembly as claimed in claim 11, wherein the switch assembly further comprises a cover engaging with the housing to define a space for accommodating the switch element, the connection element and the buttons.

13. The switch assembly as claimed in claim 12, wherein at least two first through holes are defined in the cover for receiving the at least two buttons respectively.

14. The switch assembly as claimed in claim 13, wherein the cover further comprises a positioning member for fixing the combination portion to the housing.

15. A switch assembly, comprising:
a base with at least two switch elements disposed thereon;
at least two buttons corresponding to the at least two switch elements;
a connection element configured for connecting the at least two buttons, the connection element comprising a combination portion secured to the base and at least two elastic arms connected to the combination portion, the at least two buttons being disposed on the at least two elastic arms and corresponds to the switch elements respectively.

16. The switch assembly as claimed in claim 15, wherein each elastic arm is connected to the combination portion through a connection portion.

17. The switch assembly as claimed in claim 16, wherein the connection portion extends upwardly from the combination portion, and the elastic arm is connected to an end of the connection portion which is away from the combination portion.

18. The switch assembly as claimed in claimed 17, wherein the switch assembly further comprises a positioning member for securing the combination portion to the base.
